(19) United States
(12) Patent Application Publication
(10) Pub. No.: US 2026/0105313 A1
(43) Pub. Date: Apr. 16, 2026

(54) METHODS AND SYSTEMS FOR AUGMENTING SYNTHETIC DATA LABELS WITH HUMAN-GENERATED DATA LABELS

(71) Applicants: Gopi Krishnan RAJBAHADUR, Kingston (CA); Dayi LIN, Toronto (CA); Gallaba Mudiyanselage Keheliya Bandara GALLABA, Kingston (CA); Filipe Roseiro COGO, Kingston (CA); Ahmed E. HASSAN, Kingston (CA)

(72) Inventors: Gopi Krishnan RAJBAHADUR, Kingston (CA); Dayi LIN, Toronto (CA); Gallaba Mudiyanselage Keheliya Bandara GALLABA, Kingston (CA); Filipe Roseiro COGO, Kingston (CA); Ahmed E. HASSAN, Kingston (CA)

(21) Appl. No.: 18/916,095

(22) Filed: Oct. 15, 2024

(51) Int. Cl. G06N 3/091

(52) U.S. Cl. CPC G06N 3/091

(57) ABSTRACT

There are provided methods and systems for generating a training dataset for use in supervised learning, by augmenting synthetic data labels with human-generated data labels. A preliminary training dataset corresponding to a first set of instructions is generated by a large language model (LLM). A contribution score for the preliminary training dataset is generated. Responsive to determining that the contribution score is below a threshold, human-generated data is obtained, based on a second set of instructions. An updated contribution score may be generated, based on the preliminary training dataset and the human-generated data. Responsive to determining that the updated contribution score meets or is above the threshold, the training dataset may be generated based on the preliminary training dataset and the human-generated data. The disclosed methods and systems may enable robust and efficient model performance while minimizing costs associated with labor intensive human labelling.

### FIELD

The present disclosure relates to the field of machine learning, in particular, to generating labeled training data for training machine learning models, and more specifically, to methods and systems for augmenting synthetic data labels with human-generated data labels.

### BACKGROUND

Large Language Models (LLMs), also known as Foundation Models (FMs), have emerged as transformative technologies in various industries. These models are trained on extensive generalist datasets and can be adapted to perform a wide range of specialized downstream tasks across a wide range of use cases. In this regard, FM's exhibit capabilities that extend far beyond traditional applications of artificial intelligence.

The adoption of FMs in enterprise settings typically follows a structured process. Initially, these models are pre-trained on vast amounts of general data, providing them with a broad understanding of language and context. Subsequently, they are fine-tuned on domain-specific datasets to tailor their capabilities to particular use cases. This dual-phase training process ensures that FMs are both versatile and highly specialized, making them valuable tools for a range of applications. However, effective pre-training and fine-tuning FM's relies on high-quality training data.

Accordingly, improvements in the generation of training datasets are desired.

### SUMMARY

In various examples, the present disclosure describes methods and systems for the improved generation of a training dataset for use in supervised learning by augmenting synthetic data with human-generated content in an efficient and optimized manner. Manually generating labeled training data is expensive; however, relying solely on synthetic data labeling poses other challenges, such as model collapse and model dementia. It is therefore important to combine human generated knowledge with the synthetic data to ensure optimum fine tuning performance. Embodiments of the present disclosure generate, by a LLM, a preliminary training dataset corresponding to a first set of instructions and compute a contribution score for the preliminary training dataset. Responsive to determining that the contribution score is below a threshold, human-generated data is obtained, based on a second set of instructions. An updated contribution score may be generated, based on the preliminary training dataset and the human-generated data. Responsive to determining that the updated contribution score meets or is above the threshold, the training dataset may be generated based on the preliminary training dataset and the human-generated data.

In various examples, the present disclosure provides the technical effect that a ML model can be optimally fine-tuned via supervised learning, when human-generated content is used as-needed, to enhance or augment a synthetically generated training dataset. The continuous evaluation of the augmented dataset as it is assembled, to determine when the augmented dataset meets an informativeness (or contribution score) threshold, ensures that a minimal amount of human-generated data is used to augment the training dataset, thereby keeping costs low.

In examples, optimally combining human-generated data with synthetic data (e.g., FM-generated data) based on an informativeness threshold helps to mitigate the risk of model collapse and model dementia, which can occur when ML models are trained on datasets composed of synthetic data alone. In this regard, the disclosed approach is balanced to ensure robust and efficient model performance by generating high-quality training datasets for use during fine-tuning and instruction tuning tasks, while minimizing costs associated with labor intensive human labelling.

In examples, the generation of training datasets based on an informativeness threshold may also provide advantages for generating high-quality, diverse and reliable datasets (e.g., golden datasets) that are domain and task-agnostic. Examples of the present disclosure may be used to fine-tune a wide range of FMs across various domains and tasks, enabling wider applicability. Furthermore, it is understood that poor quality data is costly, wasting valuable computational resources to produce underperforming or incorrect models. Fine tuning a ML model with a better training dataset may not only produce a better performing and more accurate model but may also reduce the computational load on computing resources (e.g., processing power, memory, computing time etc.) required for fine tuning (e.g., requiring fewer rounds of training to reach convergence). Traditionally, upon discovering that a dataset used for fine tuning was insufficient, a common approach would be to acquire more data and to repeat the fine tuning process, thereby consuming more time and resources. In this regard, speeding up model fine tuning with better data, leveraging golden datasets and avoiding model retraining may enable improvements in computational efficiency.

In an example aspect, the present disclosure describes a computer-implemented method for generating a training dataset. The method includes: generating, by an LLM, a preliminary training dataset corresponding to a first set of instructions; generating a contribution score for the preliminary training dataset, where the contribution score represents a measure of the quality of the preliminary training dataset; responsive to determining that the contribution score is below a threshold, obtaining human-generated data, based on a second set of instructions; generating an updated contribution score, based on the preliminary training dataset and the human-generated data; and responsive to determining that the updated contribution score meets or is above the threshold, generating the training dataset based on the preliminary training dataset and the human-generated data.

In an example of a preceding example aspect of the method, the method further comprising: training a machine learning model using the training dataset.

In an example of a preceding example aspect of the method, wherein the machine learning model is a foundation model, and the training comprises fine tuning the foundation model.

In an example of any of the preceding example aspects of the method, wherein the preliminary training dataset represents synthetic data, and generating the preliminary training dataset comprises: generating, by the LLM, the first set of instructions, based on seed data; and generating, by the LLM, corresponding input/output pairs for the first set of instructions.

In an example of any of the preceding example aspects of the method, wherein generating the contribution score for the preliminary training dataset comprises: generating a respective Shapley value for each data point in the preliminary training dataset; and generating the contribution score based on the Shapley values.

In an example of any of the preceding example aspects of the method, wherein obtaining human-generated data comprises: generating, by the LLM, the second set of instructions, based on the seed data and the first set of instructions; communicating, to an electronic device, the second set of instructions, to cause the electronic device to provide an output of the second set of instructions to a human user; and responsive to providing the output of the second set of instructions to a human user, receiving, from the electronic device, the human-generated data.

In an example of any of the preceding example aspects of the method, wherein generating an updated contribution score comprises: generating an augmented training dataset based on the preliminary training dataset and the human-generated data; generating a respective Shapley value for each data point in the augmented training dataset; and generating the updated contribution score based on the Shapley values.

In an example of a preceding example aspect of the method, wherein the updated contribution score represents a measure of the quality of the augmented training dataset.

In an example of any of the preceding example aspects of the method, wherein the human-generated data represents a first batch of human-generated data, the method further comprising: responsive to determining that the updated contribution score is below the threshold: generating, by the LLM, a third set of instructions, based on the seed data, the first set of instructions and the second set of instructions; communicating, to the electronic device, the third set of instructions, to cause the electronic device to provide an output of the third set of instructions to the human user; responsive to providing the output of the third set of instructions to a human user, receiving, from the electronic device, a second batch of human-generated data; and further updating the updated contribution score, based on the preliminary training dataset, the first batch of human-generated data and the second batch of human-generated data.

In an example of a preceding example aspect of the method, wherein further updating the updated contribution score comprises: generating a respective Shapley value for each data point in the second batch of human-generated data; and generating the further updated contribution score based on the Shapley values for the augmented training dataset and the Shapley values for the second batch of human-generated data.

In an example aspect, the present disclosure describes a system including: one or more processors; and a memory storing machine-executable instructions which, when executed by the one or more processors, cause the system to: generate, by an LLM, a preliminary training dataset corresponding to a first set of instructions; generate a contribution score for the preliminary training dataset, where the contribution score represents a measure of the quality of the preliminary training dataset; responsive to determining that the contribution score is below a threshold, obtain human-generated data, based on a second set of instructions; generate an updated contribution score, based on the preliminary training dataset and the human-generated data; and responsive to determining that the updated contribution score meets or is above the threshold, generate the training dataset based on the preliminary training dataset and the human-generated data.

In an example of a preceding example aspect of the system, wherein the machine-executable instructions, when executed by the one or more processors, further cause the system to: train a machine learning model using the training dataset.

In an example of a preceding example aspect of the system, wherein the machine learning model is a foundation model, and the training comprises fine tuning the foundation model.

In an example of any of the preceding example aspects of the system, wherein the preliminary training dataset represents synthetic data, and wherein the machine-executable instructions, when executed by the one or more processors to generate the preliminary training dataset, further cause the system to: generate, by the LLM, the first set of instructions, based on seed data; and generate, by the LLM, corresponding input/output pairs for the first set of instructions.

In an example of any of the preceding example aspects of the system, wherein the machine-executable instructions, when executed by the one or more processors to generate the contribution score for the preliminary training dataset, further cause the system to: generate a respective Shapley value for each data point in the preliminary training dataset; and generate the contribution score based on the Shapley values.

In an example of any of the preceding example aspects of the system, wherein the machine-executable instructions, when executed by the one or more processors to obtain human-generated data, further cause the system to: generate, by the LLM, the second set of instructions, based on the seed data and the first set of instructions; communicate, to an electronic device, the second set of instructions, to cause the electronic device to provide an output of the second set of instructions to a human user; and responsive to providing the output of the second set of instructions to a human user, receive, from the electronic device, the human-generated data.

In an example of any of the preceding example aspects of the system, wherein the machine-executable instructions, when executed by the one or more processors to generate an updated contribution score, further cause the system to: generate an augmented training dataset based on the preliminary training dataset and the human-generated data; generate a respective Shapley value for each data point in the augmented training dataset; and generate the updated contribution score based on the Shapley values.

In an example of a preceding example aspect of the system, wherein the updated contribution score represents a measure of the quality of the augmented training dataset.

In an example of any of the preceding example aspects of the system, wherein the human-generated data represents a first batch of human-generated data, the machine-executable instructions, when executed by the one or more processors, further cause the system to: responsive to determining that the updated contribution score is below the threshold: generate, by the LLM, a third set of instructions, based on the seed data, the first set of instructions and the second set of instructions; communicate, to the electronic device, the third set of instructions, to cause the electronic device to provide an output of the third set of instructions to the human user; responsive to providing the output of the third set of instructions to a human user, receiving, from the electronic device, a second batch of human-generated data; and further update the updated contribution score, based on the preliminary training dataset, the first batch of human-generated data and the second batch of human-generated data.

In some example aspects, the present disclosure describes a non-transitory computer-readable medium having machine-executable instructions stored thereon, the machine-executable instructions, when executed by a processor of a device, cause the device to: generate, by an LLM, a preliminary training dataset corresponding to a first set of instructions; generate a contribution score for the preliminary training dataset, where the contribution score represents a measure of the quality of the preliminary training dataset; responsive to determining that the contribution score is below a threshold, obtaining human-generated data, based on a second set of instructions; generate an updated contribution score, based on the preliminary training dataset and the human-generated data; and responsive to determining that the updated contribution score meets or is above the threshold, generate the training dataset based on the preliminary training dataset and the human-generated data.

In some example aspects, the present disclosure describes a non-transitory computer readable medium storing instructions thereon. The instructions, when executed by a processor, cause the processor to perform any of the preceding example aspects of the method.

### BRIEF DESCRIPTION OF THE DRAWINGS

Reference will now be made, by way of example, to the accompanying drawings which show example embodiments of the present application, and in which:

FIG. 1 is a block diagram illustrating an example computing system which may be used to implement examples of the present disclosure;

FIG. 2 shows a block diagram of an example architecture for a synthetic data augmentation network, in accordance with examples of the present disclosure;

FIG. 3 shows a block diagram of an example architecture for a data augmentation module, in accordance with examples of the present disclosure;

FIG. 4 is a flowchart illustrating an example method for generating a training dataset, in accordance with examples of the present disclosure.

Similar reference numerals may have been used in different figures to denote similar components.

### DETAILED DESCRIPTION

The following describes example technical solutions of this disclosure with reference to accompanying figures. To assist in understanding the present disclosure, some concepts relevant to neural networks and machine learning (ML) are first discussed.

Machine learning (ML) is an application of artificial intelligence (AI) that provides systems the ability to automatically learn and improve from experience without being explicitly programmed. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network, for example, an input layer that accepts inputs, an output layer that generates a prediction as output, and in the case of deep neural networks (DNN), a plurality of hidden layers which are situated between the input layer and output layer. The output of one layer may be provided as input to a subsequent layer. Thus, input to a neural network may be processed through a succession of layers until an output of the neural network is generated by a final layer.

A deep neural network (DNN) is a type of neural network having multiple layers and/or a large number of neurons. The term DNN may encompass any neural network having multiple layers, including convolutional neural networks (CNNs), recurrent neural networks (RNNs), and multilayer perceptrons (MLPs), among others. DNNs are often used as ML-based models for modelling complex behaviors in order to improve accuracy of outputs (e.g., more accurate predictions) such as, for example, as compared with models with fewer layers. In the present disclosure, the term machine learning model, or simply “ML model” may be understood to refer to a DNN.

Training of the ML model is a process of learning the values of the parameters (or weights) of the neurons in the layers such that the ML model is able to model the target behavior to a desired degree of accuracy. In the process of training a ML model, two approaches are commonly used: supervised learning and unsupervised learning. In unsupervised learning, the neural network is not provided with any information on desired outputs, and the neural network is trained to arrive at a set of learned weights on its own. In supervised learning, a predicted value outputted by the ML model may be compared to a desired target value (e.g., a ground truth value). A weight vector (which is a vector containing the weights W for a given layer) of each layer of the ML model is updated based on a difference between the predicted value and the desired target value or based on some other objective function (e.g., the minimization of a loss function, or the maximization of a reward, among other possibilities). This comparison and adjustment may be carried out iteratively until a convergence condition is met, for example, a predefined maximum number of iterations has been performed, or the value outputted by the ML model is sufficiently converged with the desired target value or objective function, after which the ML model is considered to be sufficiently trained. The values of the learned parameters may then be fixed and the ML model may be deployed to generate output in real-world applications (also referred to as “inference”).

Training typically requires the use of a training dataset, which is a set of data that is relevant to the target behavior of the ML model. The training data may be a subset of a larger data set. For example, a data set may be split into three mutually exclusive subsets: a training set, a validation (or cross-validation) set, and a testing set and the three subsets of data may be used sequentially during ML model training, or other segmentations of the larger data set and/or schemes for using the segments for training one or more ML models are possible. For example, the training set may be first used to train one or more ML models, for example, where each ML model may have unique characteristics, such as a particular architecture, a particular training procedure, being describable by a set of model hyperparameters, etc. The validation (or cross-validation) set may then be used as input data into the trained ML models to measure the performance of the trained ML models and/or compare performance between them. Once such a trained ML model is obtained, output may be generated using the trained ML model based on the third subset (the testing set), for assessing the accuracy of the trained ML model.

Backpropagation is an algorithm for training a ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Once the ML model is considered to be sufficiently trained, the values of the learned parameters may be fixed and the ML model may be deployed to generate output in real-world applications (also referred to as “inference”). In some examples, a trained ML model may be fine-tuned, meaning that the values of the learned parameters may be adjusted slightly in order for the ML model to better model a specific task. Fine-tuning of a ML model typically involves further training the ML model on a number of data samples that closely target the specific task. For example, a ML model for generating natural language that has been trained generically on publicly-available text corpuses may be fine-tuned by further training the ML model using a smaller, specific dataset.

A large language model (LLM) is a type of DNN that can perform natural language processing (NLP) tasks to summarize, translate, predict and generate text and other content. A LLM may be trained to learn billions of parameters, for example, to model how words relate to each other in a textual sequence. In examples, an LLM may be trained as a generative model (e.g., meaning that it can process input text sequences to predictively generate a meaningful output text sequence), for example, in an unsupervised manner on a large corpus derived from publicly available content, such as documents and images available to the public online. An LLM may then be fine-tuned with training datasets based on a specific application. For example, a LLM designed for chat interactions may be fine-tuned using a training dataset including chat transcripts or conversations.

In the present disclosure, a “foundation model (FM)” can mean: A ML model that has been pre-trained on a large scale and generalist (or broad) dataset and that can be adapted to perform a wide range of specialized downstream tasks.

In the present disclosure, a “large language model (LLM)” can mean: a large pre-trained language model, implemented using a DNN, that has been trained on a large corpus of data and that uses natural language processing for tasks like translation, question answering, and summarization. For example, an LLM is a type of machine learning (ML) model that may generate text output (including natural language text output), responsive to receiving a natural language input. For example, a LLM may be provided with a prompt, which may be a natural language instruction that instructs the LLM to generate a desired output. In the present disclosure, the terms FM and LLM may be used interchangeably.

In the present disclosure, “fine-tuning” can mean: The process of taking a pre-trained model and further training the model using supervised learning to improve the model performance on a specific task. For example, fine-tuning may use a training dataset of labeled examples (e.g., input/output pairs) to update the weights of the model to adapt the pre-trained model to a specific domain or task.

In the present disclosure, “instruction-tuning” can mean: A type of fine-tuning technique for adapting a pre-trained model (such as an FM) to respond to natural language instructions associated with a range of tasks. For example, in instruction-tuning, the FM is trained by supervised learning using a training dataset comprising a collection of instruction-formatted instances, where each instance can include an instruction, an input/output pair and optionally some examples demonstrating similar input/output pairs associated with the task. In the present disclosure, an “instruction-tuned LLM” is an LLM that has been fine-tuned to respond to instructions associated with a range of tasks, for example, producing an output responsive to being provided with an instruction and the corresponding input. In the present disclosure, an “instruction” can mean: a natural language text that describes a task and guides the LLM to generate a response.

In the present disclosure, a “golden dataset” can mean: a dataset or a database representing a single, well-defined, and trusted source of information.

In the present disclosure, a “Shapley value” or “Shapley score” can mean: a concept in cooperative game theory that aims to determine the contribution or relative impact of each player in the outcome of a coalition or a cooperative game. When applied to machine learning (ML) approaches, the Shapley value estimates the contribution of each feature or variable in a ML model to a predicted output.

Other terms used in the present disclosure may be introduced and defined in the following description.

Common approaches for generating training datasets for fine-tuning FMs include manual data generation (e.g., through crowdsourcing), programmatic data labeling and synthetic data generation (which may or may not be human-reviewed), among other possibilities. In examples, manual data generation is the traditional approach for obtaining annotated data, where all the data (e.g., prompts, responses, outcome labels etc.) are generated by humans, and collected, for example, via crowdsourcing platforms. An example crowdsourcing approach is described in: Ouyang, L., Wu, J., Jiang, X., Almeida, D., Wainwright, C., Mishkin, P., . . . & Lowe, R., (2022), Training language models to follow instructions with human feedback, Advances in neural information processing systems, 35, 27730-27744, the entirety of which is hereby incorporated by reference. Manual data generation can be costly and slow (e.g., highly labor intensive) and is not easily scalable. Further, manual data annotation may pose challenges for response diversity among human-generated content.

Programmatic data labeling represents an automated data labeling process that relies on user generated rules (e.g., using scripts or labeling functions), for example, using simple heuristics or more complex functions (e.g., using embeddings) to automatically label data. Such automated approaches address the costs associated with timely human annotation; however this approach is only useful for annotating data that has already been generated, therefore it does not address the challenge of data generation. Further, humans may still be required to review the automatically generated labels for quality assurance (QA).

Synthetic data generation uses LLMs to generate labeled data points. In some cases, synthetically generated datasets may still require humans to review all or some of the synthetic data points for QA, for example, to revise incorrect labels or annotate unlabeled data points. Such mixed synthetic-human approaches can still be costly in terms of human effort, for example, associated with understanding and revising individual data points. An example mixed synthetic-human approach is described in: Liu, A., Swayamdipta, S., Smith, N. A., & Choi, Y., (2022), Wanli: Worker and ai collaboration for natural language inference dataset creation, arXiv preprint arXiv:2201.05955, the entirety of which is hereby incorporated by reference. Further, as will be described in further detail below, synthetic data generation for use in model training is subject to risks associated with model collapse.

LLMs can also be used to generate synthetic datasets for fine-tuning large pre-trained models. For example, instruction-tuned language models represent LLMs that have been fine-tuned to respond to natural language instructions or “tasks”. An example instruction-tuning approach (hereafter referred to as “self-instruct”) is described in: Wang, Y., Kordi, Y., Mishra, S., Liu, A., Smith, N. A., Khashabi, D., & Hajishirzi, H., (2022), Self-instruct: Aligning language models with self-generated instructions, arXiv preprint arXiv:2212.10560, the entirety of which is hereby incorporated by reference. The “self-instruct” approach uses an LLM to automatically generate a labeled dataset based on a set of prompts to the LLM, and then uses the generated dataset to fine tune the model. However, training generative models on synthetic data alone has been found to contribute to model collapse, where the model degrades over time and increasingly generates homogenous and incorrect output. For example, continuous training on synthetic data causes the model to forget the long tails of the underlying data distribution and concentrate around the mean, producing less diverse output. An advantage of FMs is the ability to generalize and perform well outside of the data distribution, however continuous training of FMs on synthetic data eliminates this out of distribution performance. Accordingly, human-generated data is essential for effective training and fine-tuning of FMs.

In some embodiments, the present disclosure describes examples that address some or all of the above drawbacks of existing techniques for generating training datasets for fine-tuning FMs.

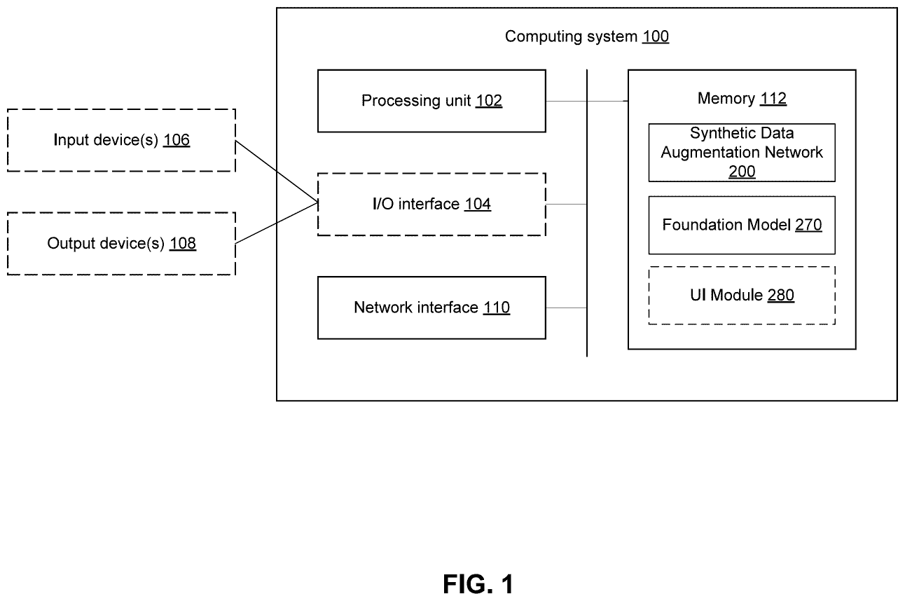

FIG. 1 is a block diagram illustrating a simplified example implementation of a computing system 100 that is suitable for implementing embodiments described herein. In some implementations, computing system 100 can be an electronic computing device, such as a networked server or a single computer. In other implementations, the computing system 100 can be a distributed computing system including multiple devices (such as a cloud computing platform) or a virtual machine running on one or more devices in mutual communication over a network. Other examples suitable for implementing implementations described in the present disclosure can be used, which can include components different from those discussed below. Although FIG. 1 shows a single instance of each component, there can be multiple instances of each component in the computing system 100. The computing system 100 may be used to execute instructions for generating a training dataset, or additionally or alternatively, for training a neural network model, using any of the examples described above. The computing system 100 may also be used to execute the trained neural network model, or the trained neural network model may be executed by another computing system.

The computing system 100 includes at least one processing unit 102 (which may have one or more processing cores), such as a processor, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof.

The computing system 100 in this example includes an input/output (I/O) interface 104, which may enable interfacing with at least one input device 106 (e.g., a camera, a keyboard, a mouse, a microphone, a touchscreen, and/or a keypad) and at least one output device 108 (e.g., a display, a speaker and/or a printer). In the example shown, the input device 106 and output device 108 are shown part of the computing system 100. In other example embodiments, the input device 106 and/or output device 108 may be external to the computing system 100. In other examples, the input device 106 and/or output device 108 may be optional, and the I/O interface 104 may also be optional.

The electronic device 100 may include one or more network interfaces (collectively referred to as network interface 110) for wired or wireless communication with a network (e.g., an intranet, the Internet, a P2P network, a WAN and/or a LAN) or another node. The network interface 106 may include wired links (e.g., Ethernet cable) and/or wireless links (e.g., one or more antennas). The computing system 100 can communicate with one or more user devices (such as user workstation computers or mobile devices, etc.), for example, for obtaining human-generated data labels, via the network interface 110.

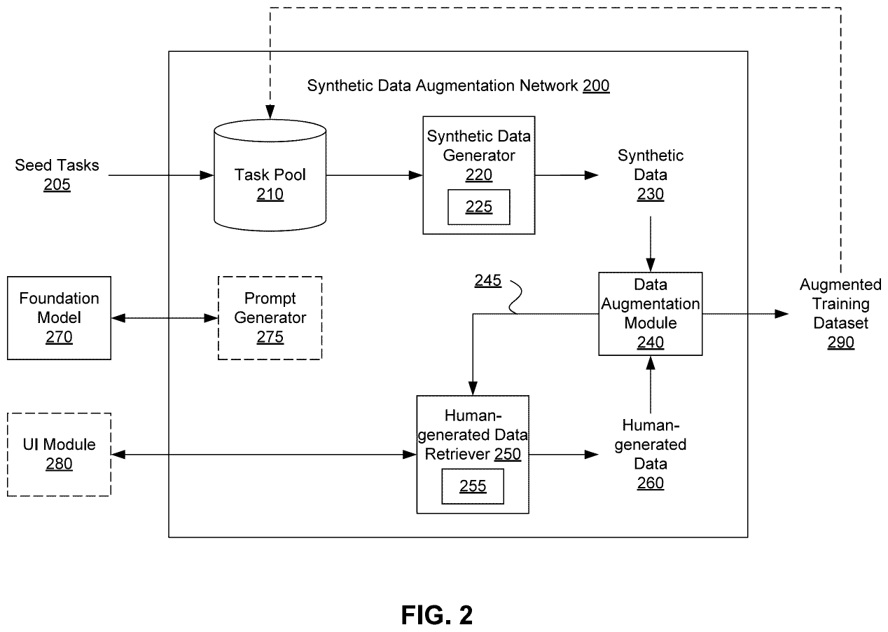

The computing system 100 may include one or more memories 112, which may include a volatile or non-volatile memory (e.g., a flash memory, a random access memory (RAM), and/or a read-only memory (ROM)). The non-transitory memory 112 may store instructions for execution by the processing unit 102, such as to carry out examples described in the present disclosure. For example, the memory 112 may store instructions for implementing any of the neural networks and methods disclosed herein. For example, the memory 112 may include instructions, executable by the processing unit 102, to implement a synthetic data augmentation network 200 as described with respect to FIG. 2 below. The memory 112 may also include instructions to implement a foundation model 270 or optionally, a UI module 280 for example, for facilitating the collection of human-generated data 260, as discussed with respect to FIG. 2 below. The memory 112 may also include instructions to implement one or more software applications (e.g., FM applications), for example, that use FMs as one of its building blocks, (e.g., ChatGPT™), among other possibilities), or other software instructions, such as for implementing an operating system and other applications/functions. The memory 112 may also include data, such as model training data or trained parameters (e.g., weight values) of a neural network, among other possibilities.

In some examples, the computing system 100 may also include an electronic storage unit (not shown), such as a solid state drive, a hard disk drive, a magnetic disk drive and/or an optical disk drive. In some examples, data and/or instructions may be provided by an external memory (e.g., an external drive in wired or wireless communication with the computing system 100) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage. The components of the computing system 100 may communicate with each other via a bus, for example.

FIG. 2 shows a block diagram of an example synthetic data augmentation network 200, in accordance with examples of the present disclosure. The synthetic data augmentation network 200 may be software that is implemented in the computing system 100 of FIG. 1, in which the processing unit 102 is configured to execute instructions of the synthetic data augmentation network 200 stored in the memory 108. The synthetic data augmentation network 200 in this example includes a task pool 210, a synthetic data generator 220, a data augmentation module 240, a human-generated data retriever 250 and optionally, a prompt generator 275 and generates an augmented training dataset 290, for example, for fine-tuning a FM (270).

In examples, the task pool 210 may be seeded with a pre-determined number of seed tasks 205. For example, the seed tasks 205 may represent manually-generated tasks, where each seed task 205 includes an instruction and a labeled input/output pair. For example, an input may represent a request (e.g., that may be posed by a user) while an output may represent a desirable response to the request. In examples, the synthetic data generator 220 may receive the pre-determined seed tasks 205 and may cooperate with an LLM such as the foundation model (FM) 270 to generate a set of instructions 225 based on the seed tasks 205. For example, one or more seed tasks 205 may be selected (e.g., randomly, among other possibilities) and the FM 270 may be prompted to generate instructions for new tasks (e.g., set of instructions 225), based on the selected seed tasks 205. In some embodiments, for example, the synthetic data generator 220 may further cooperate with the FM 270 to generate synthetic data 230 (e.g., including a collection of instruction-formatted instances, where each instance can include an instruction, an input/output pair and optionally some examples demonstrating similar input/output pairs associated with the task), based on the set of instructions 225. For example, the FM 270 may be prompted to generate corresponding input/output pairs for each of the instructions in the set of instructions 225. In this regard, the synthetic data 230 may represent a labeled synthetic dataset which can be used for supervised instruction tuning of the FM 270. In examples, the synthetic data generator 220 may communicate with a prompt generator (e.g., prompt generator 275, or the prompt generator may be a component of the synthetic data generator 220, among other possibilities) to provide one or more prompts to FM 270, for generating the set of instructions 225 and/or the synthetic data 230. An example of a self-instruction framework that can be implemented in example embodiments is described in: Wang, Y., Kordi, Y., Mishra, S., Liu, A., Smith, N. A., Khashabi, D., & Hajishirzi, H., (2022), Self-instruct: Aligning language models with self-generated instructions, arXivpreprint arXiv:2212.10560, the entirety of which is hereby incorporated by reference, or another algorithm may be used.

In some embodiments, for example, the prompt generator 275 may generate the following example prompt (example 1) for providing to the FM 270, for generating the set of instructions 225 and/or the synthetic data 230:
{“id”: “seed_task_0”, “name”: “breakfast_suggestion”, “instruction”: “Is there anything|can eat for a breakfast that doesn't include eggs, yet includes protein, and has roughly 700-1000 calories?”, “instances”: [{“input”: “ ”, “output”: “Yes, you can have 1 oatmeal banana protein shake and 4 strips of bacon. The oatmeal banana protein shake may contain ½ cup oatmeal, 60 grams whey protein powder, ½ medium banana, 1 tbsp flaxseed oil and ½ cup water, totalling about 550 calories. The 4 strips of bacon contains about 200 calories.”}], “is_classification”: false}

In some embodiments, for example, the prompt generator 275 may generate the following example prompt (example 2) for providing to the FM 270, for generating the set of instructions 225 and/or the synthetic data 230:
{“id”: “seed_task_1”, “name”: “antonym_relation”, “instruction”: “What is the relation between the given pairs?”, “instances”: [{“input”: “Night:Day::Right:Left”, “output”: “The relation between the given pairs is that they are opposites.” }], “is_classification”: false}

In some embodiments, for example, the prompt generator 275 may generate the following example prompt (example 3) for providing to the FM 270, for generating the set of instructions 225 and/or the synthetic data 230:
{“id”: “seed_task_2”, “name”: “one_sentence_description”, “instruction”: “Generate a one-sentence description for each of the following people.”, “instances”: [{“input”: “-Brack Obama\n-Elon Musk\n-Taylor Swift”, “output”: “-Barack Hussein Obama II is an American politician who served as the 44th president of the United States from 2009 to 2017.\n-Elon Musk is the founder, CEO, and chief engineer of SpaceX; angel investor, CEO and product architect of Tesla, Inc.; founder of The Boring Company; co-founder of Neuralink and OpenAI; president of the Musk Foundation; and owner and CEO of Twitter, Inc.\n-Taylor Alison Swift is an American singer-songwriter.” }], “is_classification”: false}

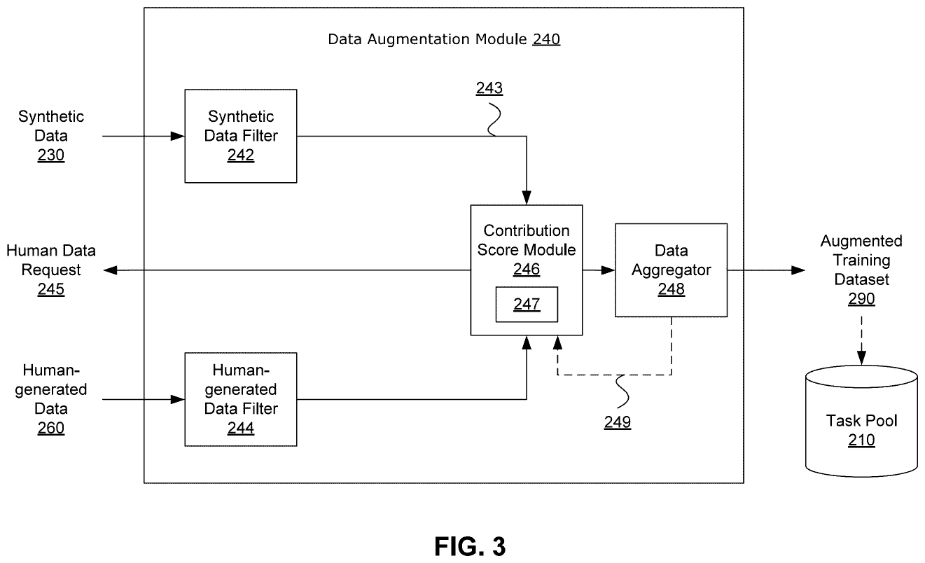

In examples, the synthetic data 230 may be provided to the data augmentation module 240 for generating an augmented training dataset 290, as described with respect to FIG. 3 below.

FIG. 3 shows a block diagram of an example architecture for the data augmentation module 240, in accordance with examples of the present disclosure. The data augmentation module 240 may be software that is implemented in the computing system 100 of FIG. 1, in which the processing unit 102 is configured to execute instructions of the data augmentation module 240 stored in the memory 108. The data augmentation module 240 in this example includes a synthetic data filter 242, a human-generated data filter 244, a contribution score module 246 and a data aggregator 248, for generating the augmented training dataset 290, for example, for fine-tuning the FM (270). Although the synthetic data filter 242, the human-generated data filter 244, the contribution score module 246 and the data aggregator 248 are shown as separate components, it is understood that the functions of each of the components can be performed by a single component, among other possibilities.

In examples, the synthetic data 230 may be received at the synthetic data filter 242 where the synthetic data 230 may be filtered (e.g., based on heuristics, similarity metrics (e.g., ROUGE-L), among other possibilities) to remove low quality instruction-formatted instances or similar instruction-formatted instances (e.g., duplicates of instruction-formatted instances that are deemed to be too similar to existing seed data or newly generated instances), for example, for increasing data quality and diversity. An example of a similarity metric that can be implemented in example embodiments is described in: Lin, C. Y. (2004, July). Rouge: A package for automatic evaluation of summaries. In Text summarization branches out (pp. 74-81), the entirety of which is hereby incorporated by reference. In examples, the filtered synthetic data may represent a preliminary training dataset 243, for example, for fine tuning the FM 270. For example, to ensure that fine-tuning tasks are performed using the best possible training data, it can be beneficial to ensure that training datasets are composed of the most informative and representative data points. In examples, the preliminary training dataset 243 may be received by the contribution score module 246 for continually evaluating the overall informativeness (e.g., based on an overall contribution score) of the preliminary training dataset 243, for example, to determine whether the preliminary training dataset 243 meets a threshold informativeness value to be used for a fine-tuning or instruction tuning task. In some embodiments, for example, the contribution score module 246 may evaluate the overall informativeness of the preliminary training dataset 243 using a contribution score that is based on Shapley values. For example, the overall contribution score for the preliminary training dataset 243 may be determined by quantifying the contribution of each data point to the model's overall performance, based on corresponding Shapley values for each data point. An example of a Shapley-based framework for evaluating the informativeness of a dataset that can be implemented in example embodiments is described in: Schoch, S., Xu, H., & Ji, Y., (2022), CS-Shapley: class-wise Shapley values for data valuation in classification, Advances in Neural Information Processing Systems, 35, 34574-34585, the entirety of which is hereby incorporated by reference.

In some embodiments, for example, as the computation of Shapley values can be computationally expensive for large datasets, the contribution score module 246 may estimate Shapley values for each data point in the preliminary training dataset 243 using a computationally efficient algorithm for Shapley-based data analysis, such as the Transferred Sampling Data Shapley (TS-D Shapley) approach, or another method may be used. An example of the TS-D Shapley approach that can be implemented in example embodiments is described in: Schoch, S., Mishra, R., & Ji, Y., (2023), Data selection for fine-tuning large language models using transferred shapley values, arXivpreprint arXiv:2306.10165, the entirety of which is hereby incorporated by reference. In examples, the contribution score module 246 may determine a Shapley value (e.g. a TS-D Shapley value) for each data point of the preliminary training dataset 243 and may cumulatively determine the overall contribution score for the preliminary training dataset 243 based on the Shapley values. In some embodiments, for example, generating the respective Shapley value for each data point comprises extracting representations (e.g., feature vectors or embeddings) from the penultimate layer of the FM model (270) and these representations may be used to train a small surrogate classification model (e.g., classifier 247). In examples, respective Shapley values may be determined for each data point in the preliminary training dataset 243 based on the classifier 247. In examples, Monte Carlo sampling may first be performed on subsets of the preliminary training dataset 243. For each Monte Carlo sampling subset, a subset of Ttraining instances (e.g., representing T data points) may then be sampled. The Shapley value of each data point may be determined, for example, by removing one instance at a time from the subset of Ttraining instances to determine a contribution of each instance on the output of the classifier 247, and repeating T times, where the Shapley value for each respective instance may then be calculated as an average of the respective contributions associated with each instance.

In examples, the overall contribution score for the preliminary training dataset 243 may be cumulatively determined, for example, based on the Shapley value for each data point in the preliminary training dataset 243. For example, the Shapley value for each data point in the preliminary training dataset 243 may be summed (and optionally, normalized) to obtain the overall contribution score. In examples, the overall contribution score for the preliminary training dataset 243 may be compared to the pre-determined informativeness threshold value to determine whether the overall contribution score is lower or higher than the pre-determined informativeness threshold value. In examples, if the overall contribution score is higher than the threshold value, the preliminary training dataset 243 may be used for a training task, such as a fine-tuning or instruction tuning task. In this regard, the overall contribution score may represent a measure of the quality of the preliminary training dataset 243, for training a model on a particular task. In examples, the preliminary training dataset 243 may be added to the task pool 210, where it may be used for future instruction tuning of the foundation model.

Responsive to determining that the overall contribution score for the preliminary training dataset 243 falls below the threshold value, the contribution score module 246 may generate a request for human-generated data (e.g., human data request 245) for augmenting the preliminary training dataset 243 with human-generated data. In examples, augmenting or integrating the preliminary training dataset 243 with human-generated data may improve the quality of the training data, thereby enhancing the performance of fine-tuned models that are trained on the augmented training data.

Returning to FIG. 2, responsive to determining that the overall contribution score for the preliminary training dataset 243 falls below the threshold value, the human generated data retriever 250 may receive the human data request 245 and may communicate with a prompt generator (e.g., prompt generator 275, or the prompt generator may be a component of the human generated data retriever 250, among other possibilities) to provide one or more prompts to FM 270, for generating one or more detailed instructions 255 for providing to a human user. In some embodiments, for example, prompts generated by the synthetic data generator 220 may be reused for generating detailed instructions 255 for providing to the human user. In examples, the one or more detailed instructions may enable the collection of human-generated data 260 that is task specific. In some embodiments, for example, the human generated data retriever 250 may cooperate with the user interface (UI) module 280, for providing the one or more detailed instructions 255 to the human user and for receiving the human-generated data 260, for example, via a user interface generated by the UI module 280. For example, the UI module 280 may interface with an electronic device, such as a mobile communication device (e.g., smartphone), a tablet device, a laptop device, a desktop device, a vehicle-based device (e.g., an infotainment system or an interactive dashboard device), a wearable device (e.g., smartwatch), an interactive kiosk device, or an Internet of Things (IoT) device, among other possibilities for outputting the one or more detailed instructions, for example, via an output device (e.g., display, speaker etc.) of the electronic device, among other possibilities. In examples, the UI module 280 may further interface with the electronic device for receiving the human-generated data 260, for example, via an input device (e.g., keyboard, touchscreen, microphone etc.) of the electronic device, among other possibilities. In examples, the human-generated data 260 may be received as a textual input, for example, received as a natural language representation via a textbox object in the user interface, or the human-generated data 260 may be received as an audio input, for example, received as a natural language representation via a microphone of the electronic device, among other possibilities.

In some embodiments, for example, the prompt generator 275 may generate the following example prompt (example 4) for providing to the FM 270, for generating one or more detailed instructions 255 for providing to a human user:

```
You are tasked with generating a request for human annotators to manually generate
and label data for a specific task. The goal is to improve the quality and diversity of a
dataset. Based on the task provided, you should construct an email request that asks
human annotators to:
1. **Create examples** relevant to the task.
2. **Label those examples** according to the given labeling criteria.
The request should be professional, clear, and provide step-by-step instructions for
generating the examples and labeling them. Here are the variables you will need to
include:
1. **Task Name**: The name of the task (e.g., ″Commit Message Labeling″, ″Customer
Feedback Sentiment Analysis″).
2. **Label 1 and Label 2**: The two primary labels that the examples should be classified
into.
3. **Criteria for Label 1**: A description of what qualifies an example for the first label.
4. **Criteria for Label 2**: A description of what qualifies an example for the second
label.
5. **Examples**: At least two examples (one for each label) to illustrate how to create
and label the data.
Generate the email request using these variables, ensuring that the instructions are
clear and that the human annotators understand how to both create and label examples.
Use the following structure:
---
**Subject**: Request for Human Annotation: [TASK NAME]
Dear Annotator,
We are requesting your assistance in manually generating and labeling examples to
improve the quality of our dataset for [TASK NAME]. Our current dataset lacks diversity,
and we need human-generated data to enhance its accuracy and representation.
**Task Description**:
Please **create examples** and then label them according to the criteria for **″[LABEL
1]″** and **″[LABEL 2]″** based on [TASK-SPECIFIC DESCRIPTION]. Examples that
meet the conditions for [LABEL 1] should be labeled accordingly, while those that fit
[LABEL 2] should receive that label.
**Instructions**:
1. **Create an example**: Provide an example that reflects typical cases related to the
task.
  - Ensure the example is realistic and provides enough context to determine the
appropriate label.
2. **Label the example**:
  - If the example meets the criteria for **″[LABEL 1]″**, label it as such.
  - If the example fits **″[LABEL 2]″**, label it accordingly.
**Examples**:
- Example: ‘[EXAMPLE 1]‘
  - **Label**: [LABEL 1]
  - **Rationale**: [RATIONALE FOR LABEL 1].
- Example: ‘[EXAMPLE 2]‘
  - **Label**: [LABEL 2]
  - **Rationale**: [RATIONALE FOR LABEL 2].
Please create a diverse set of examples, covering various scenarios related to [TASK
NAME]. Your contributions will greatly improve the overall quality of the dataset.
Thank you for your support!
Best regards,
[YOUR NAME / TEAM]
---
Now, based on this structure, please generate the request for the following task:
**Task Name**: [INSERT SPECIFIC TASK NAME]
**Label 1**: [INSERT LABEL 1 NAME]
**Label 2**: [INSERT LABEL 2 NAME]
**Criteria for Label 1**: [INSERT DESCRIPTION OF CRITERIA FOR LABEL 1]
**Criteria for Label 2**: [INSERT DESCRIPTION OF CRITERIA FOR LABEL 2]
**Example 1**: [INSERT FIRST EXAMPLE]
**Example 2**: [INSERT SECOND EXAMPLE]
```

In some embodiments, for example, the FM 270 may generate the following example output (example 5) of detailed instructions 255 for providing to a human user:
Dear Annotator,
We are requesting your assistance in manually generating and labeling examples to improve the quality of our dataset for Commit Message Labeling. Our current dataset lacks diversity, and we need human-generated data to enhance its accuracy and representation.
Task Description:
Please create commit message examples and then label them according to the criteria for “Bug Fix” and “Not a Bug Fix” based on the type of change described. Commit messages that address specific bugs or defects in the code should be labeled as “Bug Fix,” while those that involve refactoring, enhancements, or documentation updates should be labeled as “Not a Bug Fix.”
Instructions:
Create an example: Provide a commit message that reflects typical changes in a software development project.
Ensure the commit message is realistic and provides enough context to determine the appropriate label.
Label the example:
If the commit message addresses a bug or defect, label it as “Bug Fix.”
If the commit message involves other types of changes (e.g., enhancements, refactoring), label it as “Not a Bug Fix.”
Examples:
Example: Fix null pointer exception when user submits a form
Label: Bug Fix
Rationale: The commit explicitly addresses a software defect (a null pointer exception).
Example: Refactor authentication logic to improve code readability
Label: Not a Bug Fix
Rationale: This commit focuses on code refactoring for readability, which does not involve fixing a bug.
Please create a diverse set of commit message examples, covering different scenarios encountered in software development. Your contributions will greatly improve the overall quality of the dataset.

In some embodiments, the gathering of human generated data 260 may be an iterative process, for example, the human generated data retriever 250 may provide the human-generated data 260 to the data augmentation module 240 in batches, for augmenting the synthetic data 230, until the augmented training dataset 290 is effectively generated. For example, responsive to a first human data request 245, the human generated data retriever 250 may provide a first batch of human-generated data 260 to the data augmentation module 240. In examples, responsive to the data augmentation module 240 determining that more human-generated data is needed to effectively generate the augmented training dataset 290, the human generated data retriever 250 may subsequently receive a further human data request 245 and provide a further batch of human-generated data 260 to the data augmentation module 240. In examples, this process may be repeated until an informativeness metric is reached, signaling that the augmented training dataset 290 includes a sufficient combination of synthetic data and human-generated data for mitigating model collapse. In this regard, augmentation of the synthetic data 230 with human generated data 260 may be performed on an as-need basis for optimizing costs associated with obtaining human-generated data 260.

Returning to FIG. 3, the human-generated data 260 may be received at the human-generated data filter 244 where the human-generated data 260 may be filtered (e.g., based on heuristics, similarity metrics (e.g., ROUGE-L), among other possibilities) to remove low quality instruction-formatted instances or similar instruction-formatted instances, for example, for increasing data quality and diversity. In examples, the filtered human-generated data may be provided to the contribution score module 246 in batches, for example, for augmenting the preliminary training dataset 243 with filtered human-generated data. For example, the contribution score module 246 may provide the preliminary training dataset 243 to the data aggregator 248, and the data aggregator 248 may generate an augmented preliminary training dataset 249 by iteratively appending each batch of filtered human-generated data to the preliminary training dataset 243.

As previously described, to ensure that fine-tuning tasks are performed using the best possible training data, it can be beneficial to ensure that training datasets are composed of the most informative and representative data points. In this regard, batches of filtered human-generated data may be iteratively received by the contribution score module 246 for continually evaluating the overall informativeness (e.g., based on an overall contribution score) of the augmented preliminary training dataset 249 as it is assembled, for example, to determine whether the augmented preliminary training dataset 249 meets a threshold informativeness value to be used for a fine-tuning or instruction tuning task.

In some embodiments, for example, the contribution score module 246 may continuously evaluate the overall informativeness of the augmented preliminary training dataset 249, for example, responsive to receiving each batch of filtered human-generated data, using a contribution score that is based on Shapley values. As previously described, the overall contribution score may be determined by quantifying the contribution of each data point in the training dataset, to the model's overall performance, based on corresponding Shapley values for each data point. For example, with the addition of each batch of human-generated data to the augmented preliminary training dataset 249, the contribution score module 246 may estimate Shapley values (e.g., using a computationally efficient algorithm for Shapley-based data analysis, such as the TS-D Shapley approach, or another method may be used) for each data point in the augmented preliminary training dataset 249, to determine the overall contribution score. In some embodiments, for example, respective Shapley values may be determined for each data point in each batch of filtered human-generated data based on the classifier 247. In examples, depending on the size of each batch of filtered human-generated data, Monte Carlo sampling may first be performed on subsets of the batch of human-generated data 260. For each Monte Carlo sampling subset, a subset of Ttraining instances (e.g., representing Tdata points) may then be sampled. The Shapley value of each data point may be determined, for example, by removing one instance at a time from the subset of Ttraining instances to determine a contribution of each instance on the output of the classifier 247, and repeating T times, where the Shapley value for each respective instance may then be calculated as an average of the respective contributions associated with each instance.

In examples, an updated overall contribution score (e.g., representing the augmented preliminary training dataset 249) may be cumulatively determined, for example, commensurate with the addition of each batch of filtered human-generated data into the augmented preliminary training dataset 249. For example, the Shapley value for each data point in the augmented preliminary training dataset 249 may be summed (and optionally, normalized) to obtain an updated overall contribution score. In examples, the overall contribution score for the augmented preliminary training dataset 249 may be continually compared to the pre-determined informativeness threshold value to determine whether the overall contribution score is lower or higher than the pre-determined informativeness threshold value. In examples, if the overall contribution score is below the threshold value, the contribution score module 246 issues a subsequent human data request 245 to obtain a subsequent batch of human-generated data 260 and the process repeats. In examples, when the overall contribution score is higher than the threshold value, data aggregator 248 outputs the final augmented training dataset 290 based on the augmented preliminary training dataset 249. In this regard, the augmented training dataset 290 may represent a labeled training dataset which can be used for supervised instruction tuning of the FM 270. In examples, responsive to generating the augmented training dataset 290, the augmented training dataset 290 may be added to the task pool 210, where it may be used for future instruction tuning of the FM 270.

In some embodiments, for example, the contribution score module 246 may determine gaps in the preliminary training dataset 243 (or the augmented preliminary training dataset 249, as it is being assembled) that may correspond to a low informativeness, or the contribution score module 246 may determine certain areas of a model which would benefit from augmentation, for example, with human-generated data or data generated by another FM. For example, the contribution score module 246 may employ methods such as semantic clustering and topic analysis, among other possibilities, to identify gaps (e.g., to determine which topics have low coverage) and to guide the generation of one or more detailed instructions 255 for providing to a human user, to address these gaps. In this regard, the contribution score module 246 may selectively enhance the training dataset without the need for comprehensive retraining. Such a targeted approach not only improves the trained model accuracy and relevance but also reduces the computational and time resources typically associated with model retraining. By quantifying informativeness, the system can also facilitate data programming, where specific data points are programmed to enhance certain aspects of the model's performance. This approach not only improves the efficiency of the fine-tuning process but also ensures that the model remains adaptable and responsive to new challenges.

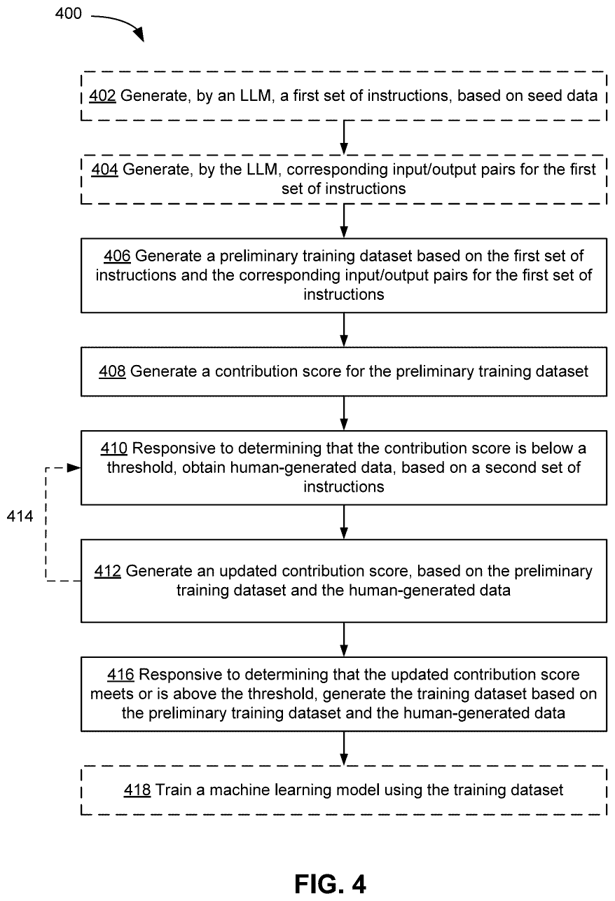

FIG. 4 is a flowchart illustrating an example method 400 for generating a training dataset, in accordance with examples of the present disclosure. The method 400 may be performed by the computing system 100. For example, the processing unit 102 may execute computer readable instructions (which may be stored in the memory 108) to cause the computing system 100 to perform the method 400.

Method 400 begins with step 402, in which seed data comprising a small set of seed tasks 205 is obtained and stored in a task pool 210. In examples, random tasks may be sampled from the task pool 210, and used to prompt an LLM (e.g., FM 270) to generate a first set of instructions 225, based on the seed data.

At step 404, the first set of instructions 225 may be used to prompt the LLM to generate corresponding instances, for example, including respective input/output pairs for each of the instructions in the first set of instructions 225.

At step 406, a preliminary training dataset 243 may be generated based on the first set of instructions and the corresponding input/output pairs.

At step 408, a contribution score may be generated for the preliminary training dataset 243, where the contribution score represents a measure of the quality of the preliminary training dataset 243, for example, with respect to fine-tuning tasks of the FM 270. In examples, in generating the contribution score, a respective Shapley value may be generated for each data point in the preliminary training dataset and the Shapley values may be summed and normalized to determine the contribution score.

At step 410, responsive to determining that the contribution score is below a threshold, human-generated data 260 may be obtained, based on a second set of instructions 255. In examples, the LLM may be prompted to generate the second set of instructions 255 for providing to a human user, for example, based on the seed data 205 and the first set of instructions 225. In examples, the second set of instructions 255 may be communicated to an electronic device to cause the electronic device to provide an output of the second set of instructions 255 to a human user. In examples, the human-generated data 260 may then be received from the electronic device.

At step 412, an updated contribution score may be generated based on the preliminary training dataset 243 and the human-generated data 260. For example, an augmented training dataset 249 may first be generated based on the preliminary training dataset 243 and the human-generated data 260. In examples, respective Shapley values may be generated for each data point in the augmented training dataset 249 and used to generate the updated contribution score. For example, the Shapley values may be summed and normalized to determine the updated contribution score. At step 414, the process may return to step 410 for one or more iterations, for example, to obtain further batches of human-generated data and to further update the contributions score based on the new batches of human-generated data, for example, until the contribution score is determined to be above the threshold.

At step 416, responsive to determining that the updated contribution score meets or is above the threshold, the training dataset 290 may be generated based on the preliminary training dataset 243 and the human-generated data 260.

At step 418, the training dataset 490 may be used to train a machine learning model (e.g., FM 270), for example, where the training comprises fine tuning the FM 270.

Examples of the present disclosure have been described in the context of instruction-tuning of a FM (such as an LLM) across various domains. A non-exhaustive list of example domains in which the present disclosure can be applied include healthcare (e.g., enhancing medical diagnosis models with high-quality, domain-specific data to improve accuracy and reliability), finance (e.g., refining predictive models for market analysis and risk assessment by integrating diverse data sources), manufacturing (e.g., optimizing predictive maintenance systems by combining sensor data with expert annotations), education (e.g., personalizing learning experiences by fine-tuning educational models with input from educators and students), among other possibilities. It should be understood that the listing of example domains provided is non-exhaustive and should not be considered to be limiting.

Various embodiments of the present disclosure having been thus described in detail by way of example, it will be apparent to those skilled in the art that variations and modifications may be made without departing from the disclosure. The disclosure includes all such variations and modifications as fall within the scope of the appended claims.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein. The machine-executable instructions may be in the form of code sequences, configuration in-formation, or other data, which, when executed, cause a machine (e.g., a processor or other processing device) to perform steps in a method according to examples of the present disclosure.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A computer-implemented method for generating a training dataset, comprising:
generating, by an LLM, a preliminary training dataset corresponding to a first set of instructions;
generating a contribution score for the preliminary training dataset, where the contribution score represents a measure of the quality of the preliminary training dataset;
responsive to determining that the contribution score is below a threshold, obtaining human-generated data, based on a second set of instructions;
generating an updated contribution score, based on the preliminary training dataset and the human-generated data; and
responsive to determining that the updated contribution score meets or is above the threshold, generating the training dataset based on the preliminary training dataset and the human-generated data.

2. The method of claim 1, further comprising:
training a machine learning model using the training dataset.

3. The method of claim 2, wherein the machine learning model is a foundation model, and the training comprises fine tuning the foundation model.

4. The method of claim 1, wherein the preliminary training dataset represents synthetic data, and generating the preliminary training dataset comprises:
generating, by the LLM, the first set of instructions, based on seed data; and
generating, by the LLM, corresponding input/output pairs for the first set of instructions.

5. The method of claim 1, wherein generating the contribution score for the preliminary training dataset comprises:
generating a respective Shapley value for each data point in the preliminary training dataset; and
generating the contribution score based on the Shapley values.

6. The method of claim 1, wherein obtaining human-generated data comprises:
generating, by the LLM, the second set of instructions, based on the seed data and the first set of instructions;
communicating, to an electronic device, the second set of instructions, to cause the electronic device to provide an output of the second set of instructions to a human user; and
responsive to providing the output of the second set of instructions to a human user, receiving, from the electronic device, the human-generated data.

7. The method of claim 1, wherein generating an updated contribution score comprises:
generating an augmented training dataset based on the preliminary training dataset and the human-generated data;
generating a respective Shapley value for each data point in the augmented training dataset; and
generating the updated contribution score based on the Shapley values.

8. The method of claim 7, wherein the updated contribution score represents a measure of the quality of the augmented training dataset.

9. The method of claim 6, wherein the human-generated data represents a first batch of human-generated data, the method further comprising:
responsive to determining that the updated contribution score is below the threshold: generating, by the LLM, a third set of instructions, based on the seed data, the first set of instructions and the second set of instructions;
communicating, to the electronic device, the third set of instructions, to cause the electronic device to provide an output of the third set of instructions to the human user;
responsive to providing the output of the third set of instructions to a human user, receiving, from the electronic device, a second batch of human-generated data; and
further updating the updated contribution score, based on the preliminary training dataset, the first batch of human-generated data and the second batch of human-generated data.

10. The method of claim 9, wherein further updating the updated contribution score comprises: generating a respective Shapley value for each data point in the second batch of human-generated data; and
generating the further updated contribution score based on the Shapley values for the augmented training dataset and the Shapley values for the second batch of human-generated data.

11. A system comprising:
one or more processors; and
a memory storing machine-executable instructions which, when executed by the one or more processors, cause the system to:
generate, by an LLM, a preliminary training dataset corresponding to a first set of instructions;
generate a contribution score for the preliminary training dataset, where the contribution score represents a measure of the quality of the preliminary training dataset;
responsive to determining that the contribution score is below a threshold, obtain human-generated data, based on a second set of instructions;
generate an updated contribution score, based on the preliminary training dataset and the human-generated data; and
responsive to determining that the updated contribution score meets or is above the threshold, generate the training dataset based on the preliminary training dataset and the human-generated data.

12. The system of claim 11, wherein the machine-executable instructions, when executed by the one or more processors, further cause the system to:
train a machine learning model using the training dataset.

13. The system of claim 12, wherein the machine learning model is a foundation model, and the training comprises fine tuning the foundation model.

14. The system of claim 11, wherein the preliminary training dataset represents synthetic data, and wherein the machine-executable instructions, when executed by the one or more processors to generate the preliminary training dataset, further cause the system to:
generate, by the LLM, the first set of instructions, based on seed data; and
generate, by the LLM, corresponding input/output pairs for the first set of instructions.

15. The system of claim 11, wherein the machine-executable instructions, when executed by the one or more processors to generate the contribution score for the preliminary training dataset, further cause the system to:
generate a respective Shapley value for each data point in the preliminary training dataset; and
generate the contribution score based on the Shapley values.

16. The system of claim 11, wherein the machine-executable instructions, when executed by the one or more processors to obtain human-generated data, further cause the system to:
generate, by the LLM, the second set of instructions, based on the seed data and the first set of instructions;
communicate, to an electronic device, the second set of instructions, to cause the electronic device to provide an output of the second set of instructions to a human user; and
responsive to providing the output of the second set of instructions to a human user, receive, from the electronic device, the human-generated data.

17. The system of claim 11, wherein the machine-executable instructions, when executed by the one or more processors to generate an updated contribution score, further cause the system to:
generate an augmented training dataset based on the preliminary training dataset and the human-generated data;
generate a respective Shapley value for each data point in the augmented training dataset; and
generate the updated contribution score based on the Shapley values.

18. The system of claim 17, wherein the updated contribution score represents a measure of the quality of the augmented training dataset.

19. The system of claim 16, wherein the human-generated data represents a first batch of human-generated data, the machine-executable instructions, when executed by the one or more processors, further cause the system to:
responsive to determining that the updated contribution score is below the threshold: generate, by the LLM, a third set of instructions, based on the seed data, the first set of instructions and the second set of instructions;
communicate, to the electronic device, the third set of instructions, to cause the electronic device to provide an output of the third set of instructions to the human user;
responsive to providing the output of the third set of instructions to a human user, receiving, from the electronic device, a second batch of human-generated data; and
further update the updated contribution score, based on the preliminary training dataset, the first batch of human-generated data and the second batch of human-generated data.

20. A non-transitory computer-readable medium having machine-executable instructions stored thereon which, when executed by a processor of a device, cause the device to:
generate, by an LLM, a preliminary training dataset corresponding to a first set of instructions;
generate a contribution score for the preliminary training dataset, where the contribution score represents a measure of the quality of the preliminary training dataset;
responsive to determining that the contribution score is below a threshold, obtaining human-generated data, based on a second set of instructions;
generate an updated contribution score, based on the preliminary training dataset and the human-generated data; and
responsive to determining that the updated contribution score meets or is above the threshold, generate the training dataset based on the preliminary training dataset and the human-generated data.
